(19) United States
(12) Patent Application Publication
(10) Pub. No.: US 2017/0053550 A1
(43) Pub. Date: Feb. 23, 2017

(54) Education System using Connected Toys

(71) Applicant: Smart Kiddo Education Limited, HONG KONG (HK)

(72) Inventors: Erwin Kam Ming LAU, HONG KONG (HK); Sam Chi Sum YU, HONG KONG (HK)

(73) Assignee: Smart Kiddo Education Limited

(21) Appl. No.: 15/158,587

(22) Filed: May 19, 2016

(30) Foreign Application Priority Data
Aug. 20, 2015 (HK) 15108086.1

(51) Int. Cl. G09B 19/00; A63H 33/26; G09B 5/02

(52) U.S. Cl. CPC G09B 19/0053; G09B 5/02; A63H 33/26

(57) ABSTRACT

An education system comprising a plurality of automation devices, a tablet computer and a data service center for programming, wherein the tablet computer is used to integrate drag-and-drop visual programming language and the plurality of automation devices to turn them into robotics and computer language educational tool; the data service center is used to provide data service support.

### CROSS-REFERENCE TO RELATED APPLICATIONS

This application claims the priority benefit of a Hong Kong patent application No. 15108086.1, filed on Aug. 20, 2015. The content of the aforementioned application, including any intervening amendments thereto, is incorporated herein by reference.

### FIELD OF THE DISCLOSURE

The present disclosure generally relates to a computer programming education tool and, in particular relates to an education system consisting of a plurality of automation devices, a tablet computer and a data service center for programming.

### BACKGROUND OF THE DISCLOSURE

Computer technology is a foundation of our modern civilization. It is becoming an new manner of education. The future lies in the hands of our next generation who can learn effectively and efficiently. Further, with the growth of connected toys via Wireless Networking and Bluetooth, there are opportunities to make use of these toys into educational instrument by computer technology.

Therefore, a development for an new education system for students is required.

### SUMMARY OF THE DISCLOSURE

In accordance with one aspect of the disclosure, an education system is disclosed. The education system may comprise a plurality of automation devices, a tablet computer and a data service center for programming, wherein the tablet computer is used to integrate drag-and-drop visual programming language and the plurality of automation devices to turn them into robotics and computer language educational tool; the data service center is used to provide data service support.

In accordance with an alternative or additional aspect of the disclosure, an education system is disclosed. The education system may comprise a plurality of automation devices, a tablet computer and a data service center for programming, wherein the tablet computer is used to integrate drag-and-drop visual programming language and the plurality of automation devices to turn them into robotics and computer language educational tool; the data service center is used to provide data service support; the tablet computer communicates with the plurality of automation devices via wireless communication, the data service center communicates with the tablet computer via internet; the plurality of automation devices are different toys, the data service center is a server-based data service center or a cloud-based data service center and comprises at least a server; each automation device comprises a CPU, a wireless transceiver, many actuators, many auxiliary hardwares, at least an indicator, many sensors and a IR emitter; the wireless transceiver, said many actuators, said many auxiliary hardwares, the at least an indicator, said many sensors and the IR emitter are electrically connected with the CPU; the wireless transceiver is used to receive command from the tablet computer and send sensor information to the tablet computer; the wireless transceiver is a WiFi transceiver or a Bluetooth transceiver; said many actuators are used to make movements of the automation devices and drive wheels of the automation devices; said many auxiliary hardwares are used to control the IR emitter and the at least an indicator; said many sensors are used to detect situation of the automation device and comprise a camera, an IR radar, a microphone, an ultrasound detector and a weight detector; the tablet computer comprises a software application that houses a visual programming language interpreter, a wireless transceiver and a number of translators; wherein the software application can implement a new educational function in the automation devices; different software applications are run on different tablet computers, different VPL programs can be written on different software applications; the visual programming language interpreter can support at least a computer language, a visual programming language program can be built in the tablet computer through visual-programming-language blocks; the visual programming language program can be integrated in the automation devices to trigger meaningful actions of the automation devices; the translators can map the functionalities of the visual-programming-language blocks to different automation devices in different sets of instructions; the server saves information of an educational function wherein the information comprises courses, lessons of each course, classes as instances of lessons with datetime and venue; the lessons have stencils and notes; the classes save the user's homework or assignment and teacher's grading and carry date and time data to indicate when a lesson is being held for particular users; the visual programming language program can be stored in the server and downloaded by the user.

Other advantages and features will be apparent from the following detailed description when read in conjunction with the attached drawings.

### BRIEF DESCRIPTION OF THE DRAWINGS

For a more complete understanding of the disclosed education system, reference should be made to the embodiments illustrated in greater detail in the accompanying drawing, wherein:

FIG. 1 is an embodiment of an education system constructed in accordance with the teachings of the disclosure;

FIG. 2 is an embodiment of a visual programming language program in accordance with the teachings of the disclosure.

It should be understood that the drawings are not necessarily to scale and that the disclosed embodiments are sometimes illustrated diagrammatically and in partial views. In certain instances, details which are not necessary for an understanding of the disclosed system, or which render other details difficult to perceive, may have been omitted. It should be understood, of course, that this disclosure is not limited to the particular embodiments illustrated herein.

### DETAILED DESCRIPTION OF THE DISCLOSURE

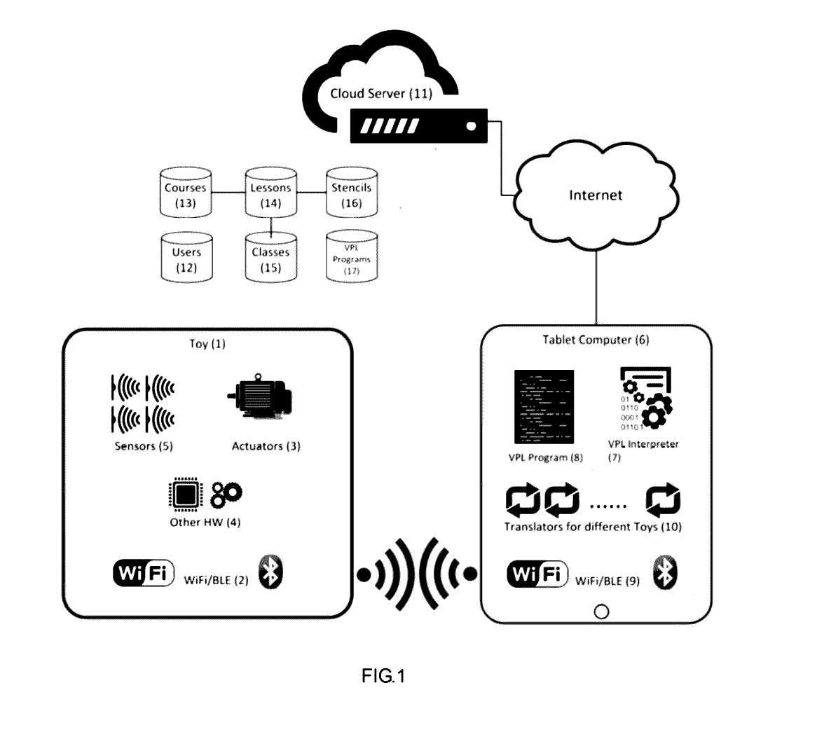

Referring now to the drawing, and with specific reference to FIG. 1, an education system may comprise a plurality of automation devices 1, a tablet computer 6 and a data service center 11 for programming, wherein the automation devices 1 are toys that kids and students like, and these toys are connected via wireless networking and Bluetooth. The tablet computer 6 may be an Ipad and can be used to integrate drag-and-drop visual programming language and the plurality of automation devices to turn them into robotics and computer language educational tool. Further, the data service center 11 is used to provide data service support, that is to say, the data service center 11 support the whole education system. When the education system is operating, the tablet computer 6 communicates with the plurality of automation devices 1 via wireless communication, the data service center 11 communicates with the tablet computer 6 via Internet. In one embodiment, the plurality of automation devices 1 are different toys, the data service center 11 is a server-based data service center or a cloud-based data service center and comprises at least a server, i.e. a cloud server.

As shown in FIG. 1, an exemplary automation device 1 comprises a CPU, a wireless transceiver 2, many actuators 3, many auxiliary hardwares 4, at least an indicator, many sensors 5 and a IR emitter. In a configuration, the wireless transceiver 2, these many actuators 3, these many auxiliary hardwares 4, the at least an indicator, these many sensors 5 and the IR emitter are electrically connected with the CPU. when the automation devices 1 is operating, the wireless transceiver 2 is used to receive command from the tablet computer and send sensor information sensed by the sensors 5 to the tablet computer 6. After the tablet computer 6 received the sensor information, the received sensor information is translated to the hardware events. Kids and students can design the VPL programs to start execution upon which particular hardware event. In an embodiment, the wireless transceiver 2 is a WiFi transceiver or a Bluetooth transceiver. These many actuators 3 are used to make movements of the automation devices e.g. leg moves, arm moves, and drive wheels of the automation devices etc. These many auxiliary hard wares are used to control the IR emitter and the at least an indicator e.g. a LED light. These many sensors are used to detect situation of the automation device 1 and comprise a camera, an IR radar, a microphone, an ultrasound detector and a weight detector.

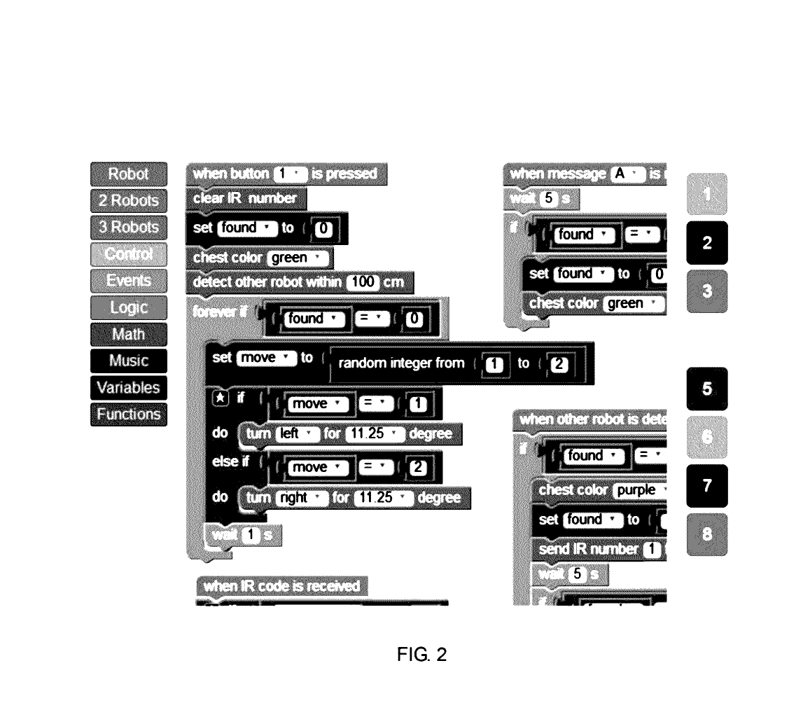

In one exemplary embodiment, the tablet computer 6 comprises a software application that houses a visual programming language (VPL) interpreter 7, a wireless transceiver 9 and a number of translators 10; wherein the software application can implement a new educational function in the automation devices 1; Different software applications are run on different tablet computers. Users like kids/students can write different VPL programs on different software applications. That is to say, the software application can utilize processing power of the tablet computer 6 to perform function that is not available in an automation device 1 e.g. Computer Vision and Image Process to build new educational block in the VPL while the automation device can only capture video stream, new educational blocks for voice recording and music playback, etc. The visual programming language interpreter 7 can support at least a computer language. A visual programming language program 8 can be built in the tablet computer 6 through visual-programming-language blocks. T he visual programming language program 8 can be integrated in the automation devices 1 to trigger meaningful actions of the automation devices. The translators 10 can map the functionalities of the visual-programming-language blocks to different automation devices 1 in different sets of instructions. Users (kids or students) can simply drag-and-drop the blocks to build the programs. When he programs on a tablet computer 6 is running, if the current execution statement (or block) is responsible to control an automation device 1 to move forward, the tablet computer 6 will then send the move forward command to the automation device 1 immediately. An example of VPL is MIT's Scratch (https://scratch.mit.edu) or Google Blockly (https://developers.google.com/blockly/). The visual programming language program 8 is multiple sequences of blocks that stringed together to perform meaningful actions. Some blocks are pure software such as software timer, variable manipulation or if/else conditional statement. Some blocks are responsible to send commands to control the actuators 3 and the auxiliary hardwares 4. The command will be sent to the automation device 1 only if the corresponding block is executed. Users like kids and students can design the VPL programs to start execution upon a particular user event e.g. button clicked, or hardware event e.g. obstacle detected by ultrasound sensor, IR received by the IR radar, a particular pattern recognized by the camera, etc., which are triggered by an automation device's sensors. Each event is represented by one event block in the VPL programs. When an event is fired, the sequence of blocks stringed after corresponding event block will start to execute. Referring now to FIG. 2, an embodiment of a visual programming language program in accordance with the teachings of the disclosure is constructed, these translators 10 that are able to integrate different remote controlled automation devices commands interpreted in the visual programming language interpreter 7, the translators 10 are done in by a process. First, the SDK (software development kit) is received from the manufacturers of the automation devices 1. Secondly, some primitive functions are done by scripting. Finally, the Blocks functionalities are mapped to different Robots by different Translators. By way of example, if a Block in a visual programming language program 8 is “Move [Forward] for [2] seconds”. And if there are two translators 10 inside he visual programming language interpreter 7. One translator is for Robot Type A, which is a two-leg robot, another translator is for Robot Type B, which is a four-wheel car. The same block may recreate two totally different sets of instructions to the Robots A or B even the action appears to be the same.

In an embodiment, the data service center 11 has account login for every user (kids or students, instructors). The server saves information of an educational function wherein the information comprises courses, lessons of each course, classes as instances of lessons with datetime and venue; the lessons have stencils and notes Le. the visual-programming-language blocks to be used in the Lesson. For example, the course “Robot Dance Programming” has eight lessons totally, two out of these eight lessons are “Move and Turn Basic” and “Sync with Music”. The datetime and venue for he class “Move and Turn Basic” is 2015 Jan. 1 14:00-15:00 and room 101 Science Park respectively. The classes save the users homework or assignment and teachers grading and carry date and time data to indicate when a lesson is being held for particular users; the visual programming language program can be stored in the server and downloaded by the user. The software application can link with several classes and instances of the automation devices simultaneously form a Lesson. Stencils (a collection of Program Blocks, User Interface Buttons, and other configurable items) are available for each Lesson. Different Lessons may have different Stencils. For example, different program blocks being allocated to t he automation device. Availability of some blocks is subject to many factors. Such as the automation device in use, teaching aim of that lessons etc. Stencils are downloaded to (6) upon Lesson/Class selection. The visual programming language program 8 are stored in Server such that students are not only able to learn in school, but also able to learn at home or other places and time. Moreover, The data service center 11 can publish user assignments with the owners consents. The VPL assignment can be collaborated to form a multi-robot performance (e.g. group dancing, soccer team etc . . . ).

While only certain embodiments have been set forth, alternatives and modifications will be apparent from the above description to those skilled in the art. These and other alternatives are considered equivalents and within the spirit and scope of this disclosure and the appended claims.

We claim:

1. An education system comprising a plurality of automation devices, a tablet computer and a data service center for programming, wherein the tablet computer is used to integrate drag-and-drop visual programming language and the plurality of automation devices to turn them into robotics and computer language educational tool; the data service center is used to provide data service support.

2. The education system according to claim 1, wherein the tablet computer communicates with the plurality of devices via wireless communication, the data service center communicates with the tablet computer via internet.

3. The education system according to claim 1, wherein the plurality of automation devices are different toys, the data service center is a server-based data service center or a cloud-based data service center and comprises at least a server.

4. The education system according to claim 1, wherein each automation device comprises a CPU, a wireless transceiver, many actuators, many auxiliary hardwares, at least an indicator, many sensors and a IR emitter; the wireless transceiver, said many actuators, said many auxiliary, the at least an indicator, said many sensors and the IR emitter are electrically connected with the CPU.

5. The education system according to claim 4, wherein the wireless transceiver is used to receive command from the tablet computer and send sensor information to the tablet computer; the wireless transceiver is a WiFi transceiver or a Bluetooth transceiver; said many actuators are used to make movements of the automation devices and drive wheels of the automation devices; said many auxiliary hardwares are used to control the IR emitter and the at least an indicator; said many sensors are used to detect situation of he automation device and comprise a camera, an IR radar, a microphone, an ultrasound detector and a weight detector.

6. The education system according to claim 1, wherein the tablet computer comprises a software application that houses a visual programming language interpreter, a wireless transceiver and a number of translators; wherein the software application can implement a new educational function in the automation devices; different software applications are run on different tablet computers, different VPL programs can be written on different software applications.

7. The education system according to claim 6, wherein the visual programming language interpreter can support at least a computer language, a visual programming language program can be built in the tablet computer through visual-programming-language blocks; the visual programming language program can be integrated in the automation devices to trigger meaningful actions of the automation devices.

8. The education system according to claim 6, wherein the translators can map the functionalities of the visual-programming-language blocks to different automation devices in different sets of instructions.

9. The education system according to claim 1, wherein the server saves information of an educational function wherein the information comprises courses, lessons of each course, classes as instances of lessons with datetime and venue; the lessons have stencils and notes; the classes save the user's homework or assignment and teachers grading and carry date and time data to indicate when a lesson is being held for particular users; the visual programming language program can be stored in the server and downloaded by the user.

10. An education system comprising a plurality of automation devices, a tablet computer and a data service center for programming, wherein the tablet computer is used to integrate drag-and-drop visual programming language and the plurality of automation devices to turn them into robotics and computer language educational tool; the data service center is used to provide data service support; the tablet computer communicates with the plurality of automation devices via wireless communication, the data service center communicates with the tablet computer via internet; the plurality of automation devices are different toys, the data service center is a server-based data service center or a cloud-based data service center and comprises at least a server; each automation device comprises a CPU, a wireless transceiver, many actuators, many auxiliary hardwares, at least an indicator, many sensors and a IR emitter; the wireless transceiver, said many actuators, said many auxiliary hardwares, the at least an indicator, said many sensors and the IR emitter are electrically connected with the CPU; the wireless transceiver is used to receive command from the tablet computer and send sensor information to the tablet computer; the wireless transceiver is a WiFi transceiver or a Bluetooth transceiver; said many actuators are used to make movements of the automation devices and drive wheels of the automation devices; said many auxiliary hardwares are used to control the IR emitter and the at least an indicator; said many sensors are used to detect situation of the automation device and comprise a camera, an IR radar, a microphone, an ultrasound detector and a weight detector; the tablet computer comprises a software application that houses a visual programming language interpreter, a wireless transceiver and a number of translators; wherein the software application can implement a new educational function in the automation devices; different software applications are run on different tablet computers, different VPL programs can be written on different software applications; the visual programming language interpreter can support at least a computer language, a visual programming language program can be built in the tablet computer through visual-programming-language blocks; the visual programming language program can be integrated in the automation devices to trigger meaningful actions of the automation devices; the translators can map the functionalities of the visual-programming-language blocks to different automation devices in different sets of instructions; the server saves information of an educational function wherein the information comprises courses, lessons of each course, classes as instances of lessons with datetime and venue; the lessons have stencils and notes; the classes save the user's homework or assignment and teacher's grading and carry date and time data to indicate when a lesson is being held for particular users; the visual programming language program can be stored in the server and downloaded by the user; when the programs on a tablet computer is running, if the current execution statement is responsible to control an automation device to move forward, the tablet computer will then send the move forward command to the automation device immediately; the VPL programs can be designed to start execution upon a particular user event or hardware event detected by ultrasound sensor, IR received by the IR radar, a particular pattern recognized by the camera which are triggered by an automation device's sensors; each event is represented by one event block in the VPL programs. when an event is fired, the sequence of blocks stringed after corresponding event block will start to execute.
